(19) United States
(12) Patent Application Publication
(10) Pub. No.: US 2021/0114152 A1
(43) Pub. Date: Apr. 22, 2021

(54) MACHINE TOOL

(71) Applicant: FANUC CORPORATION, Yamanashi (JP)

(72) Inventor: Gaku ISOBE, Yamanashi (JP)

(73) Assignee: FANUC CORPORATION, Yamanashi, JAPAN

(21) Appl. No.: 17/009,119

(22) Filed: Sep. 1, 2020

(30) Foreign Application Priority Data
Oct. 16, 2019 (JP) 2019-189132

(51) Int. Cl. B23Q 3/157; B23Q 3/155

(52) U.S. Cl. CPC B23Q 3/15713; B23Q 3/1554; B23Q 2003/155418; B23Q 2003/155428; B23Q 2003/155411

(57) ABSTRACT

A machine tool includes a spindle, a tool exchanger that attaches or detaches one of tools to or from the spindle, a spindle mover that moves the spindle to one of tool exchange coordinates when the one of the tools is to be attached or detached by the tool exchanger, and a tool exchange controller that controls, when the one of the tools is to be attached or detached by the tool exchanger, the spindle mover so as to move, on the basis of a first tool exchange coordinate associated with an attaching-target tool to be attached to the spindle and a second tool exchange coordinate associated with a detaching-target tool to be detached from the spindle, among a preliminarily-set plurality of the tool exchange coordinates respectively associated with the tools, the spindle to one of the tool exchange coordinates that are the first tool exchange coordinate and the second tool exchange coordinate, whichever is farther from a machining point.

This application is based on and claims the benefit of priority from Japanese Patent Application No. 2019-189132, filed on 16 Oct. 2019, the content of which is incorporated herein by reference.

### BACKGROUND OF THE INVENTION

### Field of the Invention

The present invention relates to a machine tool.

### Related Art

Conventionally, as a machine tool that machines a workpiece with a tool attached to a spindle, such a machine tool is known that includes a tool exchanger that holds a plurality of types of tools and that has a function capable of exchanging one of the tools for another of the tools when a type of machining for the workpiece is to be changed, to automatically support a plurality of types of machining (for example, refer to Japanese Unexamined Patent Application, Publication No. H02-53542 and the like).

Patent Document 1: Japanese Unexamined Patent Application, Publication No. H02-53542

### SUMMARY OF THE INVENTION

When tools are to be exchanged with each other, a spindle moves in its axis direction (The direction is also an axis direction of the tool.), away from a workpiece, to a tool exchange coordinate at which the tools are exchanged with each other by a tool exchanger. After the spindle has moved to the tool exchange coordinate, various types of operations take place for tool clamping and unclamping and tool removal. Specifically, tool exchange operation performed by the tool exchanger proceeds as described below.
The spindle moves to a tool exchange coordinate at which tools are to be exchanged with each other.
The tool exchanger grasps a tool attached to the spindle.
The spindle unclamps the tool.
The spindle and the tool (the tool exchanger) move relative to each other to remove the tool from the spindle.
The tool exchanger moves a tool being grasped for next use to a position of the spindle.
The spindle and the tool for next use (the tool exchanger) move relative to each other to insert the tool into the spindle.
The spindle clamps the tool for next use.
The tool exchanger releases the tool for next use being grasped.

At the tool exchange coordinate to which the spindle moves during tool exchange by the tool exchanger, a space is required, between the spindle and a workpiece, for clamping and unclamping a tool to be detached from the spindle and a tool to be newly attached to the spindle. Therefore, the tool exchange coordinate is set to a coordinate at which the largest (length in the axis direction) of such tools can be exchanged, among a plurality of types of tools used in the machine tool. Such a tool exchange coordinate has been determined so far in accordance with a configuration of the machine tool, and is not changed on the basis of each tool. Therefore, a case may arise where, in a conventional machine tool, depending on the type of tool to be detached and the type of tool to be attached, further unnecessary time is required for moving a spindle from a machining end coordinate to a tool exchange coordinate and moving the spindle from the tool exchange coordinate to a machining start coordinate after tools have been exchanged with each other. Therefore, there has been demand for a machine tool that is capable of reducing unnecessary downtime taken during tool exchange to shorten cycle time of a machining cycle.

According to an aspect of the present disclosure, a machine tool includes a spindle, a tool exchanger that attaches or detaches one of tools to or from the spindle, a spindle mover that moves, when the one of the tools is to be attached or detached by the tool exchanger, the spindle to one of tool exchange coordinates; and a tool exchange controller that controls, when the one of the tools is to be attached or detached by the tool exchanger, the spindle mover so as to move, on the basis of a first tool exchange coordinate associated with an attaching-target tool to be attached to the spindle and a second tool exchange coordinate associated with a detaching-target tool to be detached from the spindle, among a preliminarily-set plurality of the tool exchange coordinates respectively associated with the tools, the spindle to one of the tool exchange coordinates that are the first tool exchange coordinate and the second tool exchange coordinate, whichever is farther from a machining point.

According to the aspect, it is possible to provide a machine tool capable of reducing unnecessary downtime during tool exchange to shorten cycle time of a machining cycle.

### BRIEF DESCRIPTION OF THE DRAWINGS

FIG. 1 is a side view showing a machine tool according to an aspect of the present disclosure;

FIG. 2 is a plan view showing a tool exchange arm of a tool exchanger according to the aspect of the present disclosure;

FIG. 3 is a plan view showing operation of the tool exchange arm of the tool exchanger according to the aspect of the present disclosure;

FIG. 4 is a functional block diagram showing a configuration regarding tool exchange, in the machine tool according to the aspect of the present disclosure;

FIG. 5 is a view showing a reference table, which is stored in a memory unit, according to the aspect of the present disclosure;

FIG. 6 is a flowchart showing a tool exchange operation in the machine tool according to the aspect of the present disclosure;

FIG. 7 is a view showing the tool exchange operation in the machine tool according to the aspect of the present disclosure;

FIG. 8 is a view showing the tool exchange operation in the machine tool according to the aspect of the present disclosure;

FIG. 9 is a view showing the tool exchange operation in the machine tool according to the aspect of the present disclosure;

FIG. 10 is a view showing the tool exchange operation in the machine tool according to the aspect of the present disclosure;

FIG. 11 is a view showing the tool exchange operation in the machine tool according to the aspect of the present disclosure;

FIG. 12 is a view showing the tool exchange operation in the machine tool according to the aspect of the present disclosure;

FIG. 13 is a view showing the tool exchange operation in the machine tool according to the aspect of the present disclosure;

FIG. 14 is a view showing the tool exchange operation in the machine tool according to the aspect of the present disclosure;

FIG. 15 is a view showing the tool exchange operation in the machine tool according to the aspect of the present disclosure;

FIG. 16 is a view showing the tool exchange operation in the machine tool according to the aspect of the present disclosure;

FIG. 17 is a view showing the tool exchange operation in the machine tool according to the aspect of the present disclosure; and

FIG. 18 is a view showing the tool exchange operation in the machine tool according to the aspect of the present disclosure.

### DETAILED DESCRIPTION OF THE INVENTION

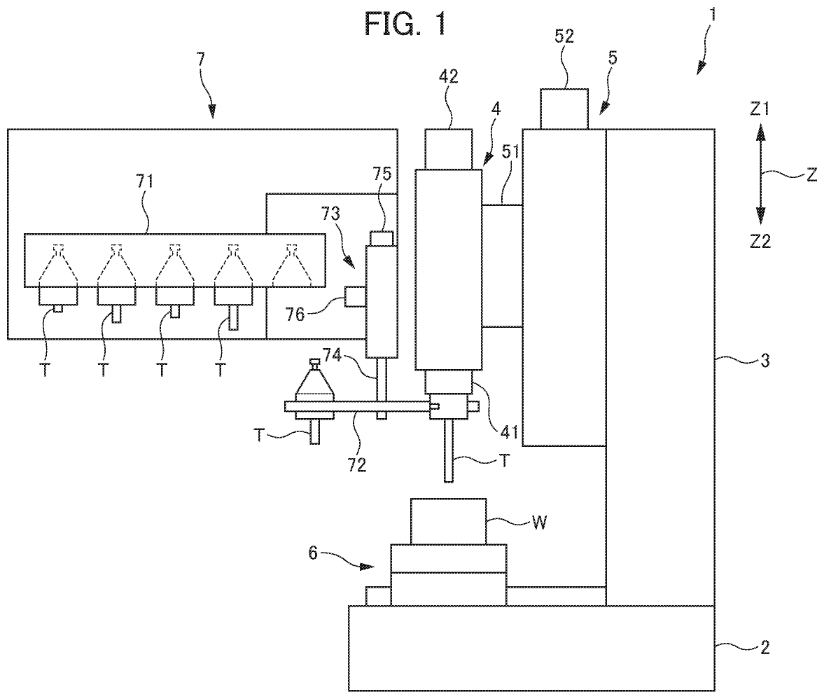

An aspect of the present disclosure will now be described herein in detail with reference to the accompanying drawings. As shown in FIG. 1, a machine tool 1 includes a base portion 2 installed on a floor surface, a column portion 3 rising upward (in a Z1 direction in FIG. 1) from the base portion 2, a spindle unit 4 disposed on a front surface side (a left side in FIG. 1) of the column portion 3, a spindle mover 5 that is provided between the spindle unit 4 and the column portion 3 and that moves the spindle unit 4 in an upper or lower direction (the Z1 direction or a Z2 direction in FIG. 1) along a Z axis, a table unit 6 that is provided on the base portion 2 and that supports a workpiece W on its top surface, and a tool exchanger 7 disposed adjacent to the spindle unit 4.

The spindle unit 4 includes, at its tip end, a spindle 41 to which one of tools T can be attached or detached, and a spindle motor 42 that rotatively drives the spindle 41. Under rotative driving of the spindle motor 42, the spindle 41 rotates one of the tools T, which is attached at the tip end, to machine the workpiece W placed below.

The spindle 41 internally includes a draw bar (not shown) used to clamp or unclamp one of the tools T. Inside the spindle 41, the draw bar moves in an advancing or retreating manner by an advancing-retreating mechanism (not shown) to clamp or unclamp one of the tools T at the tip end of the spindle 41. As the one of the tools T is clamped, the one of the tools T is attached to the spindle 41. After being unclamped, the one of the tools T moves relative to the spindle 41 in a separating direction, and is detached from the spindle 41. The advancing-retreating mechanism that moves the draw bar in an advancing or retreating manner is controlled by a tool exchange controller 100 described later.

The spindle mover 5 includes a ball screw (not shown) disposed in an extending direction of the column portion 3, a moving member 51 that screws together with the ball screw, and a Z-axis motor 52 that rotates the ball screw. The spindle unit 4 is fixed to the moving member 51. Under rotative driving of the Z-axis motor 52, the spindle mover 5 rotates the ball screw to move, via the moving member 51 that screws together with the ball screw, the spindle unit 4 in the upper or lower direction (the Z1 direction or the Z2 direction in FIG. 1) along the Z axis.

The tool exchanger 7 includes a tool magazine 71 that holds a plurality of the tools T, a tool exchange arm 72 that is capable of simultaneously grasping two of the tools T and T, and a tool exchange arm mover 73 that moves the tool exchange arm 72.

The tool magazine 71 is provided to be movable in the upper and lower directions (the Z1 direction and the Z2 direction in FIG. 1) along the Z axis by a lifting-lowering mechanism (not shown), for example, as well as is provided to be rotatively movable about the Z axis by a rotation mechanism (not shown). During tool exchange, the tool magazine 71 moves in a lifting or lowering manner, as well as rotatively moves to cause one tool T among the plurality of tools T being held to move to a position at which the one tool T can be grasped by the tool exchange arm 72. The tool magazine 71 may be a turret that holds the plurality of tools T.

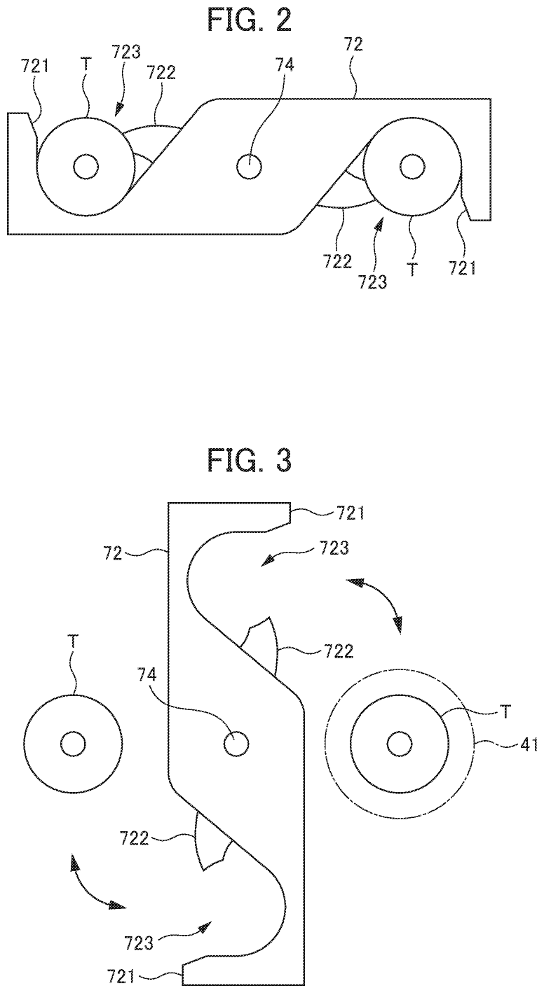

The tool exchange arm 72 includes, as shown in FIG. 2, a pair of fixed claw portions 721 and 721 respectively extending in directions opposite to each other, and a pair of movable claw portions 722 and 722 respectively disposed to face the fixed claw portions 721 and 721. Between the fixed claw portions 721 and 721 and the movable claw portions 722 and 722, respectively, recessed portions 723 and 723 respectively capable of accommodating the tools T are formed. The movable claw portions 722 and 722 are respectively provided to advance toward or retreat from the fixed claw portions 721 and 721. Therefore, when the tools T and T are respectively accommodated in the recessed portions 723 and 723, the tool exchange arm 72 grasps the tools T and T in the recessed portions 723 and 723 between the fixed claw portions 721 and 721 and the movable claw portions 722 and 722.

The tool exchange arm mover 73 includes an axis portion 74 extending in the lower direction (the Z2 direction in FIG. 1) along the Z axis, an arm rotating motor 75, and an arm lifting-lowering motor 76. Under rotative driving of the arm rotating motor 75, the axis portion 74 rotates about the Z axis. Therefore, the tool exchange arm 72 fixed to a tip end of the axis portion 74 rotates about the Z axis around the axis portion 74. Note that, under rotative driving of the arm lifting-lowering motor 76, the axis portion 74 moves in an expanding or contracting manner along the Z axis. Therefore, the tool exchange arm 72 fixed to the tip end of the axis portion 74 moves in the upper or lower direction (the Z1 direction or the Z2 direction in FIG. 1) along the Z axis. The arm rotating motor 75 and the arm lifting-lowering motor 76 form the tool exchange arm mover.

The tool exchange arm 72 in FIG. 3 shows a non-grasping state where none of the tools T and T are grasped. As the tool exchange arm 72 rotates clockwise around the axis portion 74 from the non-grasping state under rotative driving of the arm rotating motor 75, the tools T and T are respectively accommodated in the recessed portions 723 and 723, as shown in FIGS. 1 and 2. Therefore, the tool exchange arm 72 is in a grasping state where the tools T and T are respectively grasped between the fixed claw portions 721 and 721 and the movable claw portions 722 and 722. In the grasping state, the tool exchange arm 72 grasps, in one of the recessed portions 723, one of the tools T, which is removed from the tool magazine 71 (the one of the tools T is also referred to as an attaching-target tool), and grasps, in another one of the recessed portions 723, another one of the tools T, which is attached to the spindle 41 (the other one of the tools T is also referred to as a detaching-target tool).

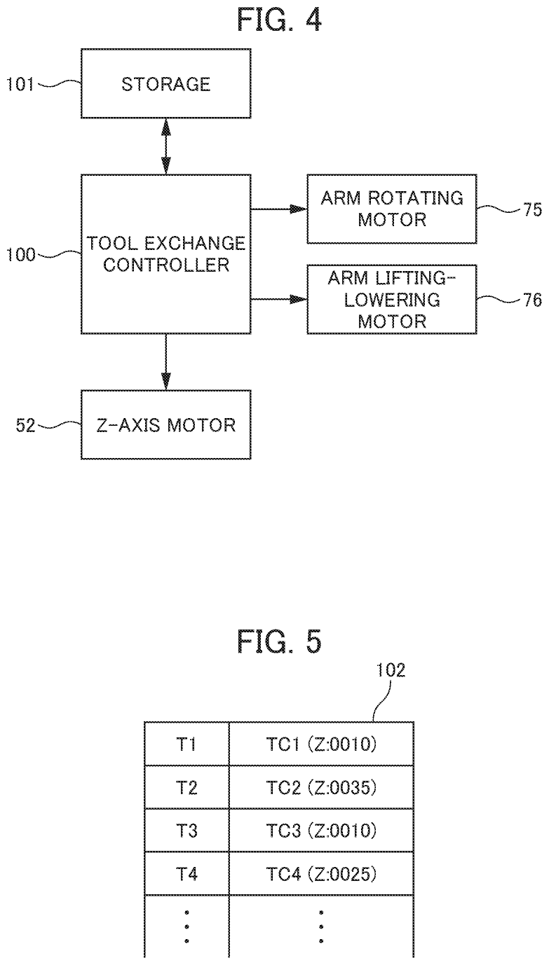

FIG. 4 is a functional block diagram showing a configuration regarding tool exchange, in the machine tool 1. As shown in FIG. 4, the machine tool 1 includes, in its control apparatus or control platform (not shown), the tool exchange controller 100 controllably coupled to the Z-axis motor 52, the arm rotating motor 75, and the arm lifting-lowering motor 76, respectively, and a memory unit 101 readably coupled to the tool exchange controller 100. The tool exchange controller 100 may be formed by a controller dedicated for tool exchange operation in the machine tool 1, or may be formed by a controller that controls whole operation of the machine tool 1.

A reference table 102 shown in FIG. 5 is stored in the memory unit 101. In the reference table 102, tool exchange coordinates TC1, TC2, TC3, TC4, etc., at which the tools T are to be each attached to or detached from the spindle 41, are set. The tool exchange coordinates TC1, TC2, TC3, TC4, etc. are associated, one by one, with a plurality of tools T1, T2, T3, T4, etc. that include the tool T attached to the spindle 41 and the tools T held by the tool magazine 71. The tool exchange coordinates TC1, TC2, TC3, TC4, etc. respectively correspond to sizes (lengths in the axis direction) of the tools T1, T2, T3, T4, etc.

The tool exchange coordinates TC1, TC2, TC3, TC4, etc. set in the reference table 102 represent coordinates on the Z axis, at which, during tool exchange, the tool exchanger 7 moves each of the tools T1, T2, T3, T4, etc., which is grasped by the tool exchange arm 72, to a clamping position or an unclamping position, relative to the spindle 41. In other words, the tool exchange coordinates TC1, TC2, TC3, TC4, etc. also represent coordinates at which, during tool exchange, a tip end 41a of the spindle 41 clamps or unclamps each of the tools T1, T2, T3, T4, etc. It is preferable that the tool exchange coordinates TC1, TC2, TC3, TC4, etc. be respectively set at positions on the Z axis, at which, during tool exchange, a tip end of each of the tools T1, T2, T3, T4, etc. does not come into contact with the workpiece W, but comes as close as possible to the workpiece W.

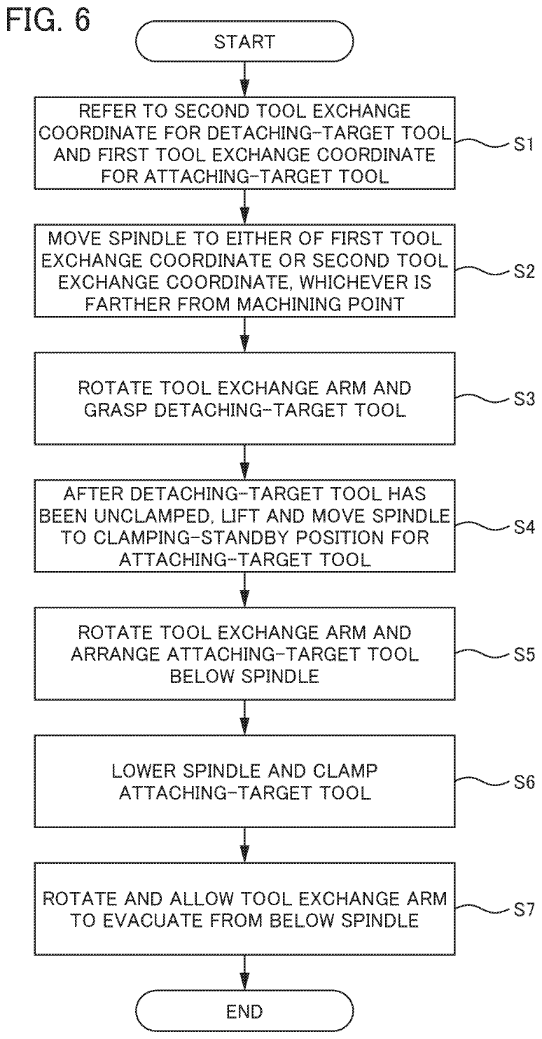

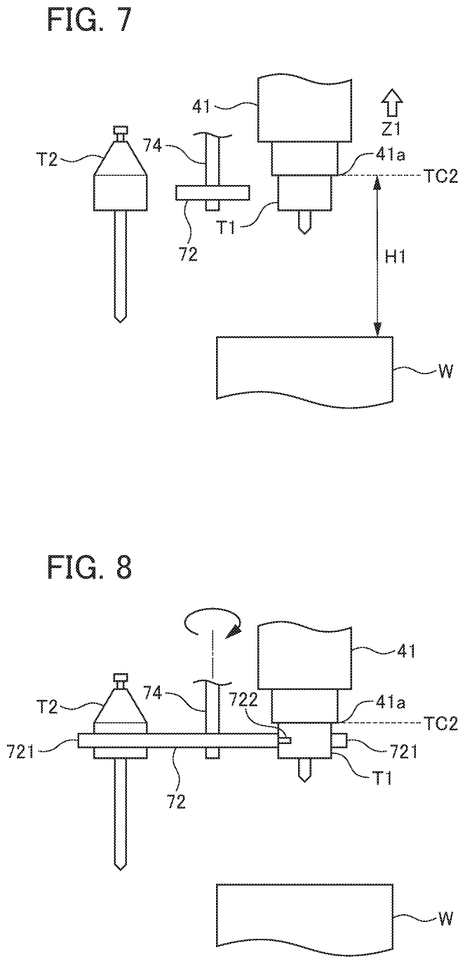

Next, specific tool exchange operation in the machine tool 1 will be described with reference to the flowchart shown in FIG. 6 and the views, showing the tool exchange operation, shown in FIGS. 7 to 18. In FIG. 7, the tool T1 having the smallest size, among the plurality of tools T to be used in the machine tool 1, is attached to the spindle 41. Firstly, such a case will be described where the tool T1 is to be exchanged with the tool T2 having the largest size, among the plurality of tools T to be used in the machine tool 1.

After completion of machining on the workpiece W with the tool T1, and when an instruction is given for exchanging the tool T1 with the tool T2, the tool exchange controller 100 refers, in the reference table 102 stored in the memory unit 101, to the tool exchange coordinate TC1 for the tool T1 that is a detaching-target tool attached to the spindle 41 and the tool exchange coordinate TC2 for the tool T2 that is an attaching-target tool to be attached to the spindle 41, as a replacement for the tool T1 (S1). In this case, the tool exchange coordinate TC1 represents a second tool exchange coordinate, whereas the tool exchange coordinate TC2 represents a first tool exchange coordinate.

After referring to the reference table 102, the tool exchange controller 100 compares with each other the tool exchange coordinate TC1 and the tool exchange coordinate TC2, and then, on the basis of the tool exchange coordinate TC1 and the tool exchange coordinate TC2, controls the Z-axis motor 52 of the spindle mover 5 to lift the spindle unit 4. Therefore, the tool exchange controller 100 causes the tip end 41a of the spindle 41 and the tool T1 attached to the spindle 41 to move to one of the tool exchange coordinates, whichever is farther from a machining point on the workpiece W (a surface of the workpiece W) (S2). In a case where the tool T1 is to be exchanged with the tool T2, the tool T1 is greater in size than the tool T2. Thus, the tool exchange coordinate TC2 represents a farther coordinate from the machining point than the tool exchange coordinate TC. Therefore, the tool exchange controller 100 causes, at Step S2, the tip end 41a of the spindle 41 and the tool T1 attached to the spindle 41 to move to the tool exchange coordinate TC2, as shown in FIG. 7. The tool exchange coordinate TC2 is set to a position away upward from the workpiece W by a height H1 at which the tool T2 does not come into contact with the workpiece W even when the tool T2 is attached to the spindle 41.

A position, on the Z axis, of the tool T2 held by the tool magazine 71 at this time is arranged at the tool exchange coordinate TC2, as the tool magazine 71 is lifted. In FIG. 7, the illustration of the tool magazine 71 is omitted, and the tool T2 is only shown. The tool exchange arm 72 is in the non-grasping state (see FIG. 3), and is arranged at a position on the Z axis, at which the two tools T1 and T2 each arranged at the tool exchange coordinate TC2 can be grasped.

After the tip end 41a of the spindle 41 and the tool T1 have moved to the tool exchange coordinate TC2, the tool exchange controller 100 controls the arm rotating motor 75 to rotate the tool exchange arm 72 being in the non-grasping state clockwise by an angle of 90° to make the tool exchange arm 72 in the grasping state. Therefore, the tool exchange arm 72 grasps the tool T1 (S3). At this time, the tool T2 is also arranged identically at a position on the Z axis, i.e., at the tool exchange coordinate TC2. Therefore, as shown in FIG. 8, the tool exchange arm 72 rotates and simultaneously grasps the tool T1 and the tool T2. After the tool T2 has been grasped by the tool exchange arm 72, the tool T2 is removed from the tool magazine 71 (not shown), as the tool magazine 71 is lifted.

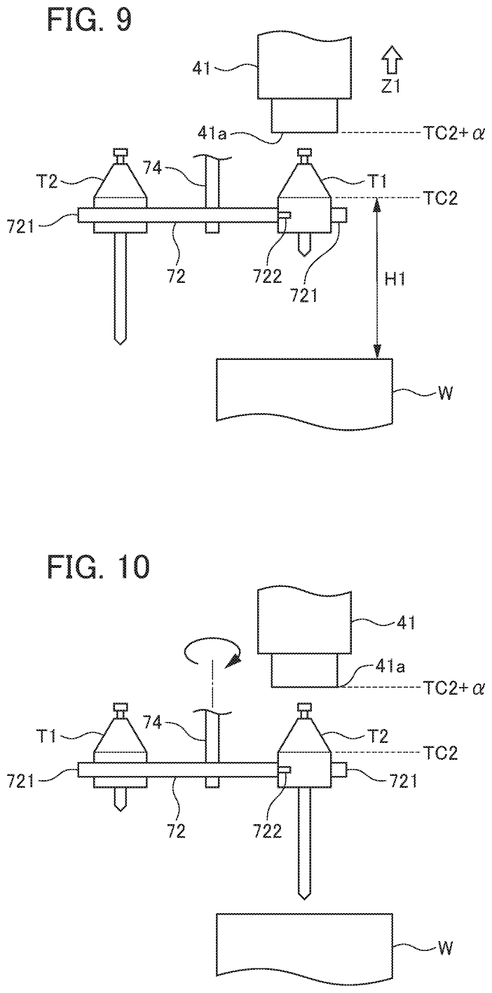

After the tool exchange arm 72 has grasped the tools T1 and T2, the tool exchange controller 100 causes the draw bar in the spindle 41 to move and unclamp the tool T1. After that, the tool exchange controller 100 controls, as shown in FIG. 9, the Z-axis motor 52 to lift the spindle unit 4, and then causes the tip end 41a of the spindle 41 to move to a clamping-standby position TC2+α for the tool T2 to be attached next. Therefore, the tool T1 is detached from the spindle 41 (S4). The tip end 41a of the spindle 41, which has moved to the clamping-standby position TC2+α for the tool T2, is arranged higher by a value of the letter a than the height H1, with respect to the workpiece W.

The letter “α” shown in the clamping-standby position TC2+α at which the tip end 41a of the spindle 41 is arranged represents a value by which the clamping-standby position TC2+α is farther away, in the Z1 direction, from the workpiece W, than the tool exchange coordinate TC2. The value of the letter “a” is set to such a value that, when the tool exchange arm 72 rotates, a detaching-target tool (the tool T1) arranged at the tool exchange coordinate TC2 can be moved from below the spindle 41, and an attaching-target tool (the tool T2) can be arranged below the spindle 41 at a position at which the attaching-target tool can come as close as possible to the workpiece W. One reason for this is that a distance at which the spindle 41 moves for clamping an attaching-target tool can be shortened to reduce time from completion of clamping to restart of machining. The value of the letter “a” is set to a constant value, regardless of the type (size) of the tools T.

Next, the tool exchange controller 100 controls the arm rotating motor 75 to rotate the tool exchange arm 72 only by an angle of 180°×n (the letter n represents an odd number of 1 or greater). Therefore, the tool exchange controller 100 causes, as shown in FIG. 10, the tool T1 to move from below the spindle 41, as well as causes the tool T2 to be arranged below the spindle 41 (S5).

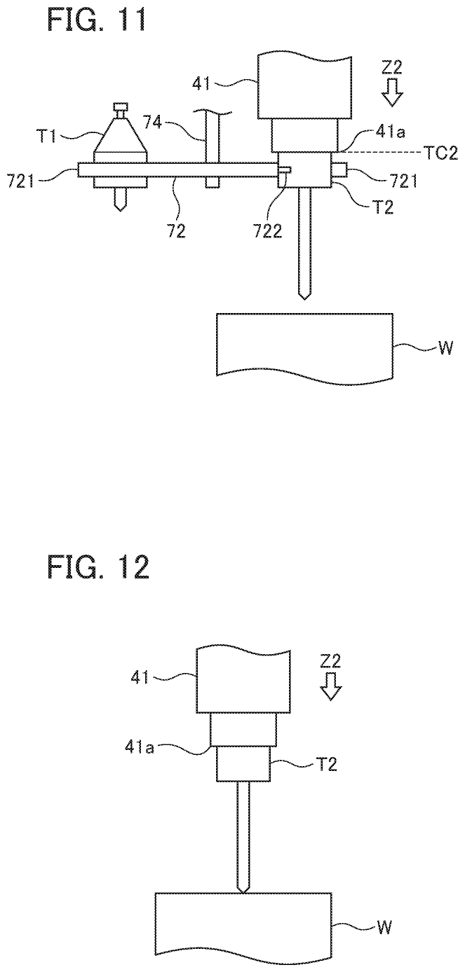

After the tool T2 has been arranged below the spindle 41, the tool exchange controller 100 controls the Z-axis motor 52 to lower the spindle unit 4 only by a distance corresponding to the value of the letter “α”. Therefore, the tool exchange controller 100 causes, as shown in FIG. 11, the tip end 41a of the spindle 41 to move to the tool exchange coordinate TC2, as well as causes the spindle 41 to clamp the tool T2 (S6). At this time, the tool T1 is held by the tool magazine 71, as the tool magazine 71 (not shown) is lowered. After that, the tool exchange controller 100 controls the arm rotating motor 75 to cause the tool exchange arm 72 to be in the non-grasping state, and then causes the tool exchange arm 72 to move from below the spindle 41 (S7).

Through the operation described above, the tool T2 is newly attached to the spindle 41, as a replacement for the tool T. After the tool T2 has been attached to the spindle 41, the machine tool 1 restarts machining on the workpiece W with the tool T2, as shown in FIG. 12.

Next, such a case will be described where the tool T1 having the smallest size and attached to the spindle 41 is to be exchanged with the tool T3 that is identical in size to the tool T1, among the plurality of tools T to be used in the machine tool 1. The tool exchange operation in this case is also executed in accordance with the flowchart shown in FIG. 6.

After completion of machining on the workpiece W with the tool T1, and when an instruction is given for exchanging the tool T1 with the tool T3, the tool exchange controller 100 refers, in the reference table 102 stored in the memory unit 101, to the tool exchange coordinate TC1 for the tool T1 that is a detaching-target tool attached to the spindle 41 and the tool exchange coordinate TC3 for the tool T3 that is an attaching-target tool to be attached to the spindle 41, as a replacement for the tool T1 (S1). In this case, the tool exchange coordinate TC1 represents the second tool exchange coordinate, whereas the tool exchange coordinate TC3 represents the first tool exchange coordinate.

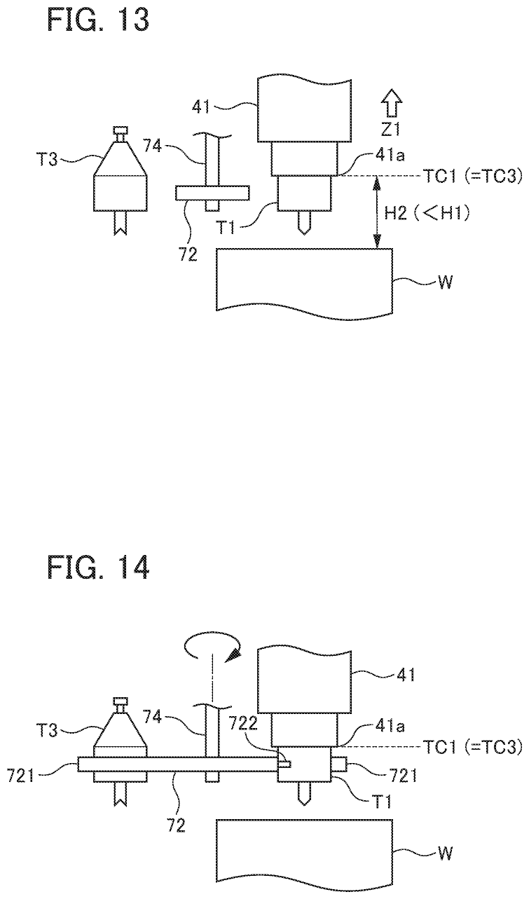

After referring to the reference table 102, the tool exchange controller 100 compares with each other the tool exchange coordinate TC1 and the tool exchange coordinate TC3, and then, on the basis of the tool exchange coordinate TC1 and the tool exchange coordinate TC3, controls the Z-axis motor 52 of the spindle mover 5 to lift the spindle unit 4. Therefore, the tool exchange controller 100 causes the tip end 41a of the spindle 41 and the tool T1 attached to the spindle 41 to move to one of the tool exchange coordinates, whichever is farther from a machining point on the workpiece W (the surface of the workpiece W) (S2). In a case where the tool T1 is to be exchanged with the tool T3, the tool T1 and the tool T3 are identical in size, and thus the tool exchange coordinate TC1 and the tool exchange coordinate TC3 represent identical coordinates. Therefore, the tool exchange controller 100 causes, at Step S2, the tip end 41a of the spindle 41 and the tool T1 attached to the spindle 41 to move to the tool exchange coordinate TC1 (=TC3), as shown in FIG. 13. The tool exchange coordinate TC1 (=TC3) is set to a position away upward from the workpiece W by a height H2 at which the tool T1 does not come into contact with the workpiece W. The height H2 is lower than the height H1 described above.

At this time, the tool T3 held by the tool magazine 71 is arranged at the tool exchange coordinate TC1, as the tool magazine 71 is lowered. Even in FIG. 13, the illustration of the tool magazine 71 is omitted, and the tool T3 is only shown. The tool exchange arm 72 is in the non-grasping state (see FIG. 3), and is arranged at a position on the Z axis, at which the tools T1 and T3 each arranged at the tool exchange coordinate TC1 can be grasped.

After the tip end 41a of the spindle 41 and the tool T1 have moved to the tool exchange coordinate TC1, the tool exchange controller 100 controls the arm rotating motor 75 to rotate the tool exchange arm 72 being in the non-grasping state clockwise by an angle of 90° to make the tool exchange arm 72 in the grasping state. Therefore, the tool exchange arm 72 grasps the tools T1 and T3, as shown in FIG. 14 (S3). After the tool T3 has been grasped by the tool exchange arm 72, the tool T3 is removed from of the tool magazine 71 (not shown), as the tool magazine 71 is lifted.

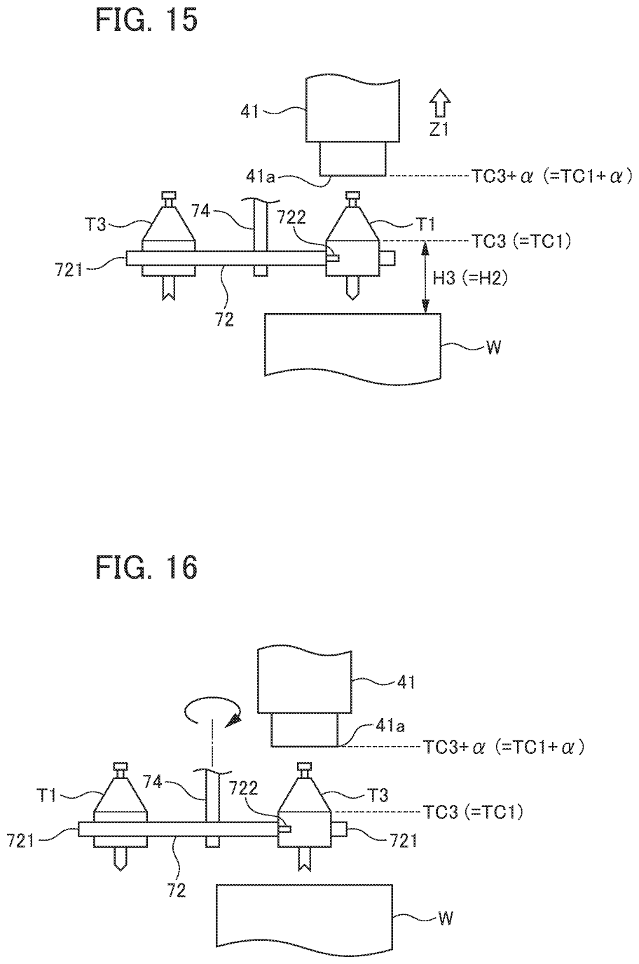

After the tool exchange arm 72 has grasped the tools T1 and T3, the tool exchange controller 100 causes the draw bar in the spindle 41 to move and unclamp the tool T1. After that, on the basis of the tool exchange coordinate TC3 that has been referred to, the tool exchange controller 100 controls, as shown in FIG. 15, the Z-axis motor 52 to lift the spindle unit 4, and then causes the tip end 41a of the spindle 41 to move to a clamping-standby position TC3+α for the tool T3 to be attached next. Therefore, the tool T1 is detached from the spindle 41 (S4).

Since the tool T3 is identical in size to the tool T1, the tool exchange coordinate TC3 for the tool T3 is identical to the tool exchange coordinate TC1 for the tool T1, as well as the clamping-standby position TC3+α for the tool T3 is identical to a clamping-standby position TC1+α for the tool T1. A height H3 to the tool exchange coordinate TC3 with respect to the workpiece W is identical to the height H2 to the tool exchange coordinate TC1 with respect to the workpiece W. Therefore, at Step S4, the tip end 41a of the spindle 41 immediately after the tool T1 has been detached stops at the clamping-standby position TC3+α (=TC1+α) for the tool T3 to be attached next, and does not move any longer in the Z1 direction. The spindle 41 keeps a standby state at the position (TC1+α=TC3+α) at which the tool T1 has been detached. Note that the position of the tool exchange arm 72 in a Z-axis direction also does not change.

Next, the tool exchange controller 100 controls the arm rotating motor 75 to rotate the tool exchange arm 72 only by an angle of 180°×n (the letter n represents an odd number of 1 or greater). Therefore, the tool exchange controller 100 causes, as shown in FIG. 16, the tool T1 to move from below the spindle 41, as well as causes the tool T3 to be arranged below the spindle 41 (S5).

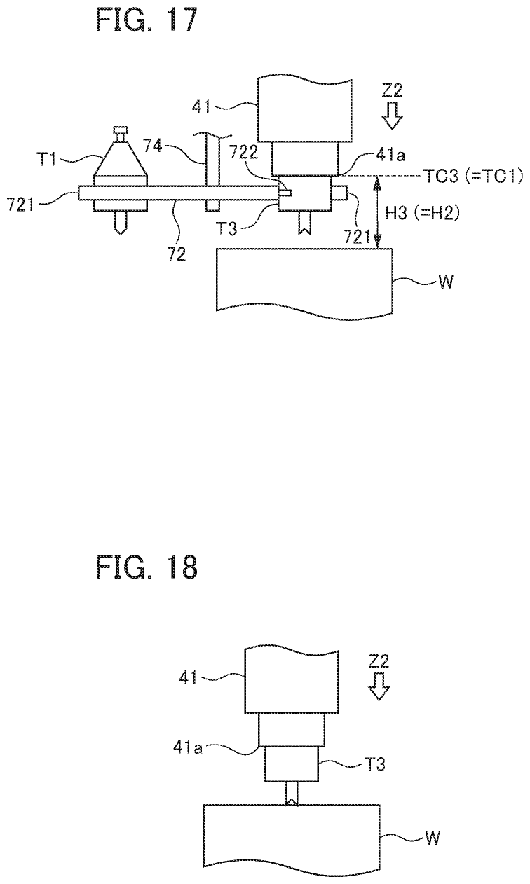

After the tool T3 has been arranged below the spindle 41, the tool exchange controller 100 controls the Z-axis motor 52 to lower the spindle unit 4 only by a distance corresponding to the value of the letter “α”. Therefore, the tool exchange controller 100 causes, as shown in FIG. 17, the tip end 41a of the spindle 41 to move to the tool exchange coordinate TC3, as well as causes the spindle 41 to clamp the tool T3 (S6). At this time, the tool T1 is held by the tool magazine 71 (not shown). After that, the tool exchange controller 100 controls the arm rotating motor 75 to cause the tool exchange arm 72 to be in the non-grasping state, and then causes the tool exchange arm 72 to move from below the spindle 41 (S7).

Through the operation described above, the tool T3 is newly attached to the spindle 41, as a replacement for the tool T1. After the tool T3 has been attached to the spindle 41, the machine tool 1 restarts machining on the workpiece W with the tool T3, as shown in FIG. 18.

As described above, the tool exchange controller 100 in the machine tool 1 controls, when one of the tools T is to be attached or detached, the spindle mover 5 (the Z-axis motor 52) so as to move, on the basis of the first tool exchange coordinate associated with an attaching-target tool to be attached to the spindle 41 and the second tool exchange coordinate associated with a detaching-target tool to be detached from the spindle 41, the spindle 41 to one of the tool exchange coordinates that are the first tool exchange coordinate and the second tool exchange coordinate, whichever is farther from a machining point. Therefore, as described above, the height H2 (=H3) to which the tools T1 and T3 and the spindle 41 move during exchange from the tool T1 having the smallest size to the tool T3 also having the smallest size can be reduced, compared with the height H1 to which the tools T1 and T2 and the spindle 41 move during exchange from the tool T1 having the smallest size to the tool T2 having the largest size. That is, an amount at which the tools T and the spindle 41 move during tool exchange becomes minimum in accordance with the sizes (lengths in the axis direction) of the tools T. Therefore, tool exchange time required for exchange from the tool T1 having the smallest size to the tool T3 also having the smallest size can become shorter, compared with tool exchange time required for exchange from the tool T1 having the smallest size to the tool T2 having the largest size, shortening the tool exchange time. Thus, according to the machine tool 1, it is possible to reduce unnecessary downtime during tool exchange to shorten cycle time of a machining cycle.

The machine tool 1 described above is configured, when one of the tools T is to be clamped or unclamped, to cause the one of the tools T to come to standstill, but to move the spindle unit 4 in the upper or lower direction. With this configuration, it is not necessary to secure, between one of the tools T and the workpiece W, a space for removing the one of the tools T downward from the spindle 41 during tool exchange, allowing the spindle 41 to come as close as possible to the workpiece W during tool exchange. Therefore, it is possible to shorten to minimum a required distance at which the spindle 41 moves during a period from completion of tool exchange to restart of machining. However, the one of the tools T and the spindle unit 4 (the spindle 41) may at least move relative to each other. Thus, the machine tool 1 may be configured, when one of the tools T is to be clamped or unclamped, to cause the spindle unit 4 to come to a standstill, but to move the one of the tools T in the upper or lower directions.

Note that the machine tool 1 described above is configured to cause the tool exchange arm 72 to grasp an attaching-target tool or a detaching target. However, in a case where the tool magazine 71 that holds the plurality of tools T is formed by a turret, the machine tool 1 may be configured, without using the tool exchange arm 72, to directly attach or detach an attaching-target tool or a detaching-target tool between the turret and the spindle 41.

A robot may be used to attach or detach one of the tools T to or from the spindle 41, instead of using the tool exchange arm 72. Note that the axis direction of the spindle 41 and the tools T in the machine tool 1 is not limited to be arranged in the upper and lower directions, but may be arranged in a lateral direction or an oblique direction.

### EXPLANATION OF REFERENCE NUMERALS

1 Machine tool
41 Spindle
5 Spindle mover
7 Tool exchanger
100 Tool exchange controller
T, T1, T2, T3, T4 Tool
TC1, TC2, TC3, TC4 Tool exchange coordinate

What is claimed is:

1. A machine tool, comprising:
a spindle;
a tool exchanger that attaches or detaches one of tools to or from the spindle;
a spindle mover that moves, when the one of the tools is to be attached or detached by the tool exchanger, the spindle to one of tool exchange coordinates; and
a tool exchange controller that controls, when the one of the tools is to be attached or detached by the tool exchanger, the spindle mover so as to move, on a basis of a first tool exchange coordinate associated with an attaching-target tool to be attached to the spindle and a second tool exchange coordinate associated with a detaching-target tool to be detached from the spindle, among a preliminarily-set plurality of the tool exchange coordinates respectively associated with the tools, the spindle to one of the tool exchange coordinates that are the first tool exchange coordinate and the second tool exchange coordinate, whichever is farther from a machining point.

2. The machine tool according to claim 1, wherein the tool exchanger is configured to move, when one of the tools is to be attached or detached, the one of the tools to one of the tool exchange coordinates, and
the tool exchange coordinates serve as coordinates to each of which the tool exchanger moves the attaching-target tool or the detaching-target tool to a clamping position or an unclamping position for the spindle.

3. The machine tool according to claim 1, wherein the tool exchange coordinates serve as coordinates to each of which the spindle clamps or unclamps the attaching-target tool or the detaching-target tool.
